(19) United States
(12) Patent Application Publication
(10) Pub. No.: US 2022/0226911 A1
(43) Pub. Date: Jul. 21, 2022

(54) RIM DRILLING AND MILLING MACHINE

(71) Applicant: TOP-ONE MACHINERY CO., LTD., TAICHUNG CITY (TW)

(72) Inventor: Tsui-O Liu, TAICHUNG CITY (TW)

(21) Appl. No.: 17/150,543

(22) Filed: Jan. 15, 2021

(51) Int. Cl. B23C 3/02; B23C 3/16

(52) U.S. Cl. CPC B23C 3/02; B23C 3/16

(57) ABSTRACT

A rim drilling and milling machine has a bottom base, a table, and a clamping unit. The clamping unit is fixed on the table and has a clamping base and multiple clamping members. Each clamping member has at least one jaw each having a jaw body, a clamping groove recessed in the jaw body, and an abutting protrusion formed between a top surface of the jaw body and the clamping groove. A distance defined from a bottom surface of the clamping groove of each of the at least one jaw to a bottom surface of the bottom base ranges from 850 millimeters to 1000 millimeters. The rim drilling and milling machine can firmly and stably clamp a wheel rim, and the wheel rim can be clamped at a position for a user to easily see a processing area of the wheel rim.

### BACKGROUND OF THE INVENTION

### 1. Field of the Invention

The present invention relates to a rim drilling and milling machine, and more particularly to a rim drilling and milling machine that can firmly and stably clamp a wheel rim.

### 2. Description of Related Art

With reference to FIGS. 8 and 8A, a conventional rim drilling and milling machine, such as a rim drilling and milling machine disclosed by U.S. Pat. No. 10,610,989 B1, substantially has a base 91, a column 92, a turret 93, a saddle 94, a table 95, and a fixture unit 96. The column 92 is fixed on the base 91 and protrudes upwardly from the base 91. The turret 93 is vertically and slidably connected with the column 92. The saddle 94 is horizontally, linearly and slidably connected with the base 91. The table 95 is horizontally, linearly and slidably connected with the saddle 94 and has a sliding direction perpendicular to a sliding direction of the saddle 94. The fixture unit 96 is fixed on the table 95 and has multiple radially arranged and slidable clamping seats 961 for clamping a wheel rim.

However, the conventional rim drilling and milling machine has the following shortcomings:

1. A distance L2 defined from a top of the fixture unit 96 to a bottom of the base 91 is around 1333 millimeters. When a wheel rim is clamped by the fixture unit 96, a distance L1 defined from a top of the wheel rim to the bottom of the base 91 is around 1650 millimeters. Consequently, the wheel rim is located too high from the ground, and it is difficult for a user to see a processing area of the wheel rim while operating the conventional rim drilling and milling machine. Therefore, it is inconvenient to operate the conventional rim drilling and milling machine.

2. A bottom of each one of the clamping seats 961 is an inclined surface 962. While the clamping seats 961 are sliding inwardly, the wheel rim can slide relative to the clamping seats 961 along the inclined surfaces 962 of the clamping seats 961 to abut against the claws 963 of the clamping seats 961. However, when drilling or processing the wheel rim by the conventional rim drilling and milling machine, the wheel rim is vibrated easily because the bottom of the wheel rim is held on the inclined surfaces 962 of the clamping seats 961. Consequently, the fixture unit 96 cannot firmly and stably clamp the wheel rim, which reduces the machining quality.

To overcome the shortcomings, the present invention tends to provide a rim drilling and milling machine to mitigate or obviate the aforementioned problems.

### SUMMARY OF THE INVENTION

The main objective of the invention is to provide a rim drilling and milling machine that can firmly and stably clamp a wheel rim, and the wheel rim can be clamped at a position for a user to easily see a processing area of the wheel rim.

The rim drilling and milling machine has a bottom base, a column, a turret, a saddle, a table, and a clamping unit. The column is fixed on the bottom base and protrudes upwardly from a top of the bottom base. The turret is connected with the column and is vertically and linearly slidable. The saddle is connected with the bottom base and is horizontally and linearly slidable. The table is horizontally, linearly and slidably connected with the saddle, and a sliding direction of the table is perpendicular to a sliding direction of the saddle. The clamping unit is fixed on a top of the table and has a clamping base and multiple clamping members. The clamping base is mounted on the table and has a center. The clamping members are arranged around the center of the clamping base at angular intervals, and are radially and slidably connected with the clamping base. Each one of the clamping members has at least one jaw.

Each one of the at least one jaw has a jaw body, a clamping groove recessed in a side of the jaw body facing the center of the clamping base, and an abutting protrusion. The jaw body of each one of the at least one jaw is formed on a top of the clamping member and protrudes upwardly. The clamping groove of each one of the at least one jaw has a top surface spaced from a top surface of the jaw body, a bottom surface spaced from the top surface of the clamping groove, and a side surface extending from an edge of the top surface of the clamping groove away from the center of the clamping base to an edge of the bottom surface of the clamping groove away from the center of the clamping base.

The abutting protrusion is formed between the top surface of the jaw body and the top surface of the clamping groove and extends from the side surface of the clamping groove toward the center of the clamping base. A distance defined from the bottom surface of the clamping groove of each of the at least one jaw of each one of the clamping members of the clamping unit to a bottom surface of the bottom base ranges from 850 millimeters to 1000 millimeters.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a rim drilling and milling machine in accordance with the present invention;

FIG. 2 is a side view of the rim drilling and milling machine in FIG. 1;

FIG. 3 is a front view of the rim drilling and milling machine in FIG. 1;

FIG. 4 is an enlarged perspective view of the rim drilling and milling machine in FIG. 1, wherein the bottom base, the column, the turret, and a saddle are omitted;

FIG. 4A is a further enlarged perspective view of the rim drilling and milling machine in FIG. 4;

FIG. 5 is an enlarged front view of the rim drilling and milling machine in FIG. 1, wherein the bottom base, the column, the turret, and a saddle are omitted;

FIG. 6 is an enlarged operational side view of the rim drilling and milling machine in FIG. 1 showing the clamp seats clamping a wheel rim, wherein the bottom base, the column, the turret, and a saddle are omitted;

FIG. 7 is an operational side view of the rim drilling and milling machine in FIG. 1;

FIG. 8 is an operational side view of a conventional rim drilling and milling machine; and

FIG. 8A is an enlarged view of the conventional rim drilling and milling machine in FIG. 8.

### DETAILED DESCRIPTION OF PREFERRED EMBODIMENT

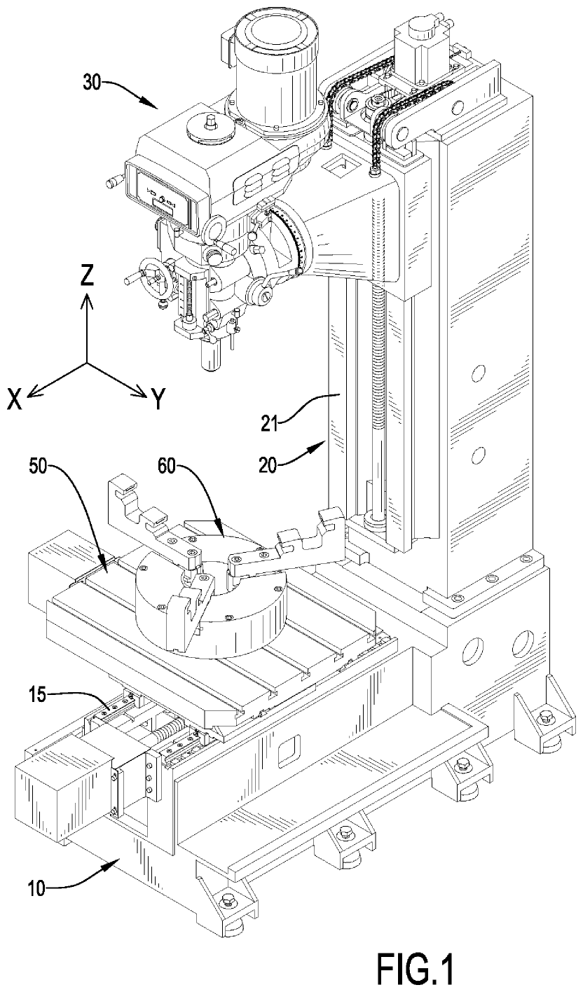

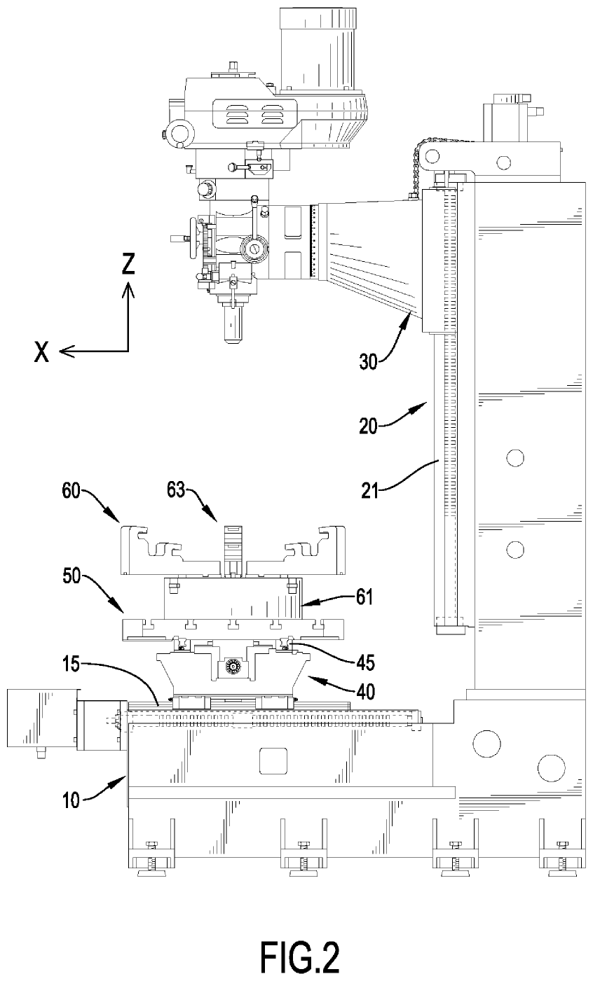

With reference to FIGS. 1 to 3, a rim drilling and milling machine in accordance with the present invention has a first axis X, a second axis Y, a third axis Z, a bottom base 10, a column 20, a turret 30, a saddle 40, a table 50, and a clamping unit 60. The first axis X, the second axis Y, and the third axis Z are perpendicular to one another, and the third axis Z is vertical and perpendicular to the horizontal plane.

The column 20 is fixed on the bottom base 10 and protrudes upwardly from the top of the bottom base 10. The turret 30 is connected with the column 20 and is vertically and linearly slidable. A vertical rail unit 21 extending along the third axis Z is mounted between the column 20 and the turret 30 to drive the turret 30 to vertically slide relative to the column 20.

The saddle 40 is connected with the bottom base 10 and is horizontally and linearly slidable along the first axis X. A first rail unit 15 is mounted between the bottom base 10 and the saddle 40 to drive the saddle 40 to slide relative to the bottom base 10 along the first axis X. The first rail unit 15 may be a lead screw device.

The table 50 is horizontally, linearly and slidably connected with the saddle 40 along the second axis Y and has a sliding direction perpendicular to a sliding direction of the saddle 40. A second rail unit 45 is mounted between the table 50 and the saddle 40 to drive the table 50 to slide relative to the saddle 40 along the second axis Y. The second rail unit 45 may be a lead screw device.

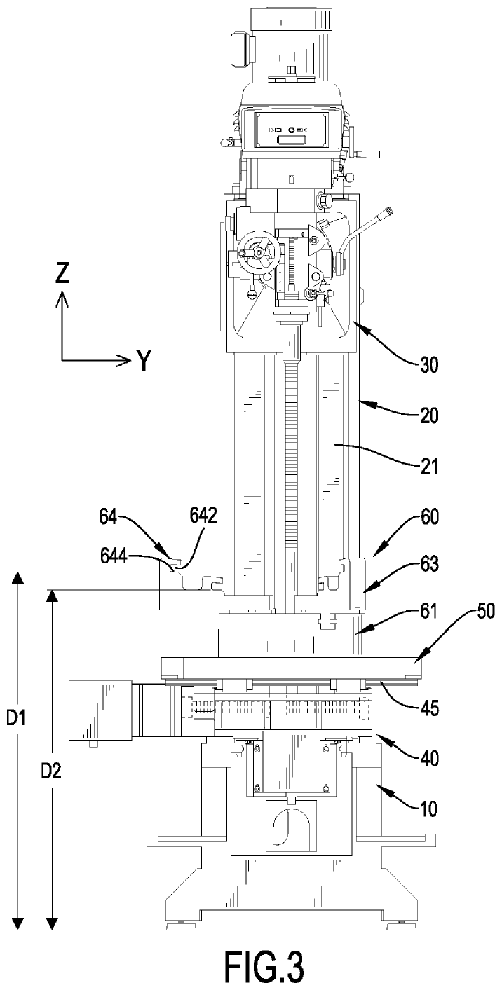

With reference to FIGS. 3, 4, 4A, and 5, the clamping unit 60 is fixed on the table 50 and has a clamping base 61 and multiple clamping members 63. The clamping base 61 is fixed on the table 50 and has a center 611. The clamping base 61 is a cylinder and is fixed on a top of the table 50 by multiple bolts. The clamping members 63 are arranged around the center 611 of the clamping base 61 at angular intervals and are radially and slidably connected with the clamping base 61.

In the embodiment, the clamping unit 60 has three clamping members 63 arranged around the center 611 of the clamping base 61 at equiangular intervals. Each one of the clamping members 63 is connected with the clamping base 61 by a sliding seat 615. Each one of the sliding seats 615 is radially and slidably mounted in the clamping base 61 and drives a corresponding one of the clamping members 63 to radially slide relative to the clamping base 61. The sliding seats 615 are connected with each other by a linkage unit such that the sliding seats 615 can be driven to radially slide relative to each other at the same time by the linkage unit. The linkage unit may be conventional, and the detailed description thereof is omitted.

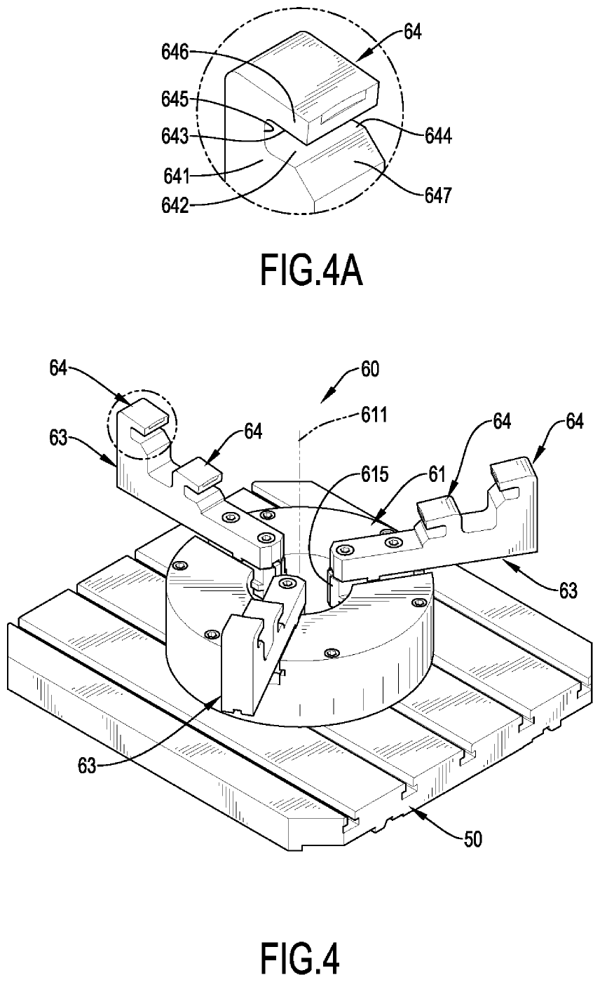

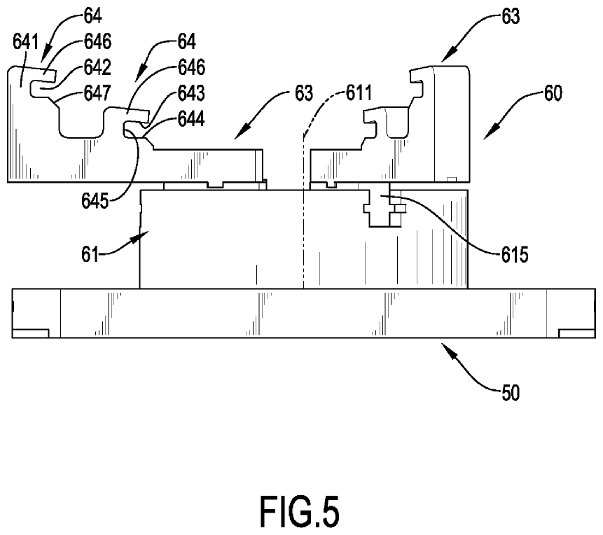

With reference to FIGS. 4, 4A, and 5, each one of the clamping members 63 has at least one jaw 64. Each of the at least one jaw 64 has a jaw body 641, a clamping groove 642, and an abutting protrusion 646. The jaw body 641 is formed on a top of the clamping member 63 and protrudes upwardly. The clamping groove 642 is recessed in a side of the jaw body 641 facing the center 611 of the clamping base 61 and extends away from the center 611 of the clamping base 61. The clamping groove 642 has a top surface 643, a bottom surface 644, and a side surface 645. The top surface 643 of the clamping groove 642 is spaced from a top surface of the jaw body 641. The bottom surface 644 of the clamping groove 642 is spaced from the top surface 643 of the clamping groove 642. The bottom surface 644 of the clamping groove 642 is a horizontal plane surface. The side surface 645 of the clamping groove 642 extends from an edge of the top surface 643 of the clamping groove 642 away from the center 611 of the clamping base 61 to an edge of the bottom surface 644 of the clamping groove 642 away from the center 611 of the clamping base 61.

The clamping groove 642 further has a chamfer 647 extending obliquely and downwardly from an edge of the bottom surface 644 of the clamping groove 642 near the center 611 of the clamping base 61. The abutting protrusion 646 is formed between the top surface of the jaw body 641 and the top surface 643 of the clamping groove 642 and extends from the side surface 645 of the clamping groove 642 toward the center 611 of the clamping base 61.

As shown in FIG. 3, a distance D1/D2 defined from the bottom surface 644 of the clamping groove 642 to a bottom surface of the bottom base 10 ranges from 850 millimeters to 1000 millimeters.

With reference to FIGS. 4, 4A, 5, and 6, preferably, each one of the clamping members 63 has multiple jaws 64 arranged longitudinally at spaced intervals. The top surface of the jaw body 641 of one of two adjacent said jaws 64 of each one of the clamping members 63 near the center 611 of the clamping base 61 is lower than the bottom surface 644 of the clamping groove 642 of the other one of the two adjacent jaws 64 of each of the clamping members 63 away from the center 611 of the clamping base 61. When a wheel rim 70 is clamped by the jaws 64 of the clamping members 63 arranged away from the center 611 of the clamping base 61, the wheel rim 70 may not contact the jaws 64 of the clamping members 63 arranged near the center 611 of the clamping base 61.

As shown in FIG. 3, the distance D1, D2 defined from the bottom surface 644 of the clamping groove 642 of each jaw 64 of each one of the clamping members 63 to the bottom surface of the bottom base 10 ranges from 850 millimeters to 1000 millimeters. The distance D1 defined from the bottom surface 644 of the clamping groove 642 of one of the jaws 64 away from the center 611 of the clamping base 61 of each one of the clamping members 63 to the bottom surface of the bottom base 10 is larger than the distance D2 defined from the bottom surface 644 of the clamping groove 642 of another one of the jaws 64 near the center 611 of the clamping base 61 of each one of the clamping members 63 to the bottom surface of the bottom base 10.

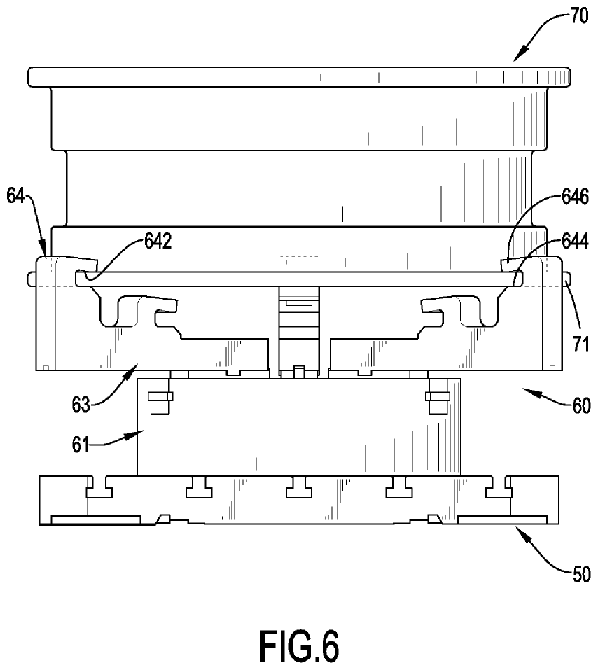

With reference to FIGS. 5 and 6, because each jaw 64 has a clamping groove 642 and an abutting protrusion 646, when the wheel rim 70 is clamped by the clamping unit 60, a bottom flange 71 of the wheel rim 70 is mounted in the clamping grooves 642 of the jaws 64 of the clamping members 63, and an external annular surface of the wheel rim 70 is abutted by the abutting protrusions 646 of the jaws 64 of the clamping members 63. Thus, the wheel rim 70 can be firmly and stably clamped by the clamping unit 60. In addition, because the bottom surfaces 644 of the clamping grooves 642 of the jaws 64 are horizontal plane surfaces, the bottom flange 71 of the wheel rim 70 can be stably held on the bottom surfaces 644 of the clamping grooves 642 to reduce the vibration of the wheel rim 70 during drilling or processing the wheel rim 70. Accordingly, the processing quality can be enhanced.

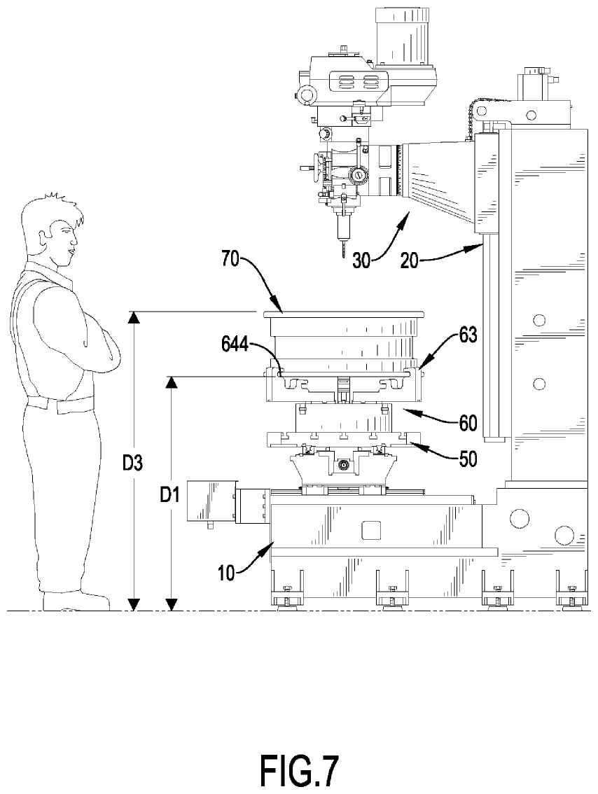

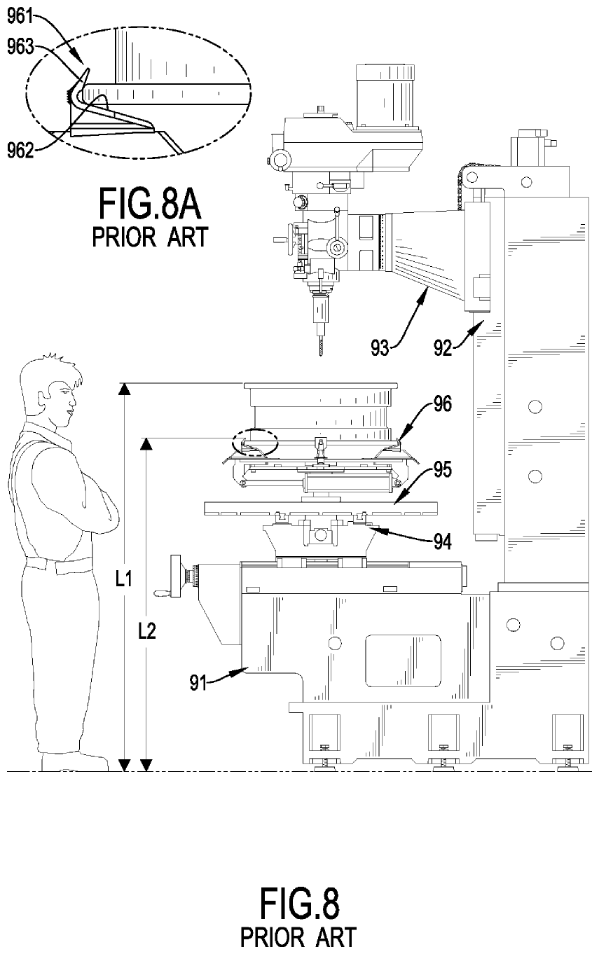

With reference to FIGS. 3 and 7, the distance D1/D2 defined from the bottom surface 644 of the clamping groove 642 of each of the jaws 64 of each of the clamping members 63 to the bottom surface of the bottom base 10 ranges from 850 millimeters to 1000 millimeters. For example, if the distance D1 is 955 millimeters and a width of the wheel rim 70 is 317 millimeters, when the wheel rim 70 is clamped by the clamping unit 60, a distance D3 defined from the top of the wheel rim 70 to the bottom surface of the bottom base 10 will be 1272 millimeters.

Therefore, the wheel rim 70 will not be located too high from the ground and will be located at a proper height for a user to easily see a processing area of the wheel rim 70. The user can easily operate the rim drilling and milling machine of the present invention to drill or process the wheel rim 70. With such arrangement, the rim drilling and milling machine in accordance with the present invention can firmly and stably clamp a wheel rim 70. Vibration of the wheel rim 70 during drilling and processing can be reduced. The user can easily see the processing area of the wheel rim 70. The operating convenience and the processing quality of the rim drilling and milling machine can be enhanced.

What is claimed is:

1. A rim drilling and milling machine comprising:
a bottom base;
a column fixed on the bottom base and protruding upwardly from a top of the bottom base;
a turret connected with the column and being vertically and linearly slidable;
a saddle connected with the bottom base and being horizontally and linearly slidable;
a table horizontally, linearly and slidably connected with the saddle, and having a sliding direction perpendicular to a sliding direction of the saddle; and
a clamping unit fixed on a top of the table and having
a clamping base mounted on the table and having a center; and
multiple clamping members arranged around the center of the clamping base at angular intervals, radially and slidably connected with the clamping base, and each one of the clamping members having at least one jaw, each of the at least one jaw having
a jaw body formed on a top of the clamping member and protruding upwardly;
a clamping groove recessed in the jaw body from a side of the jaw body facing the center of the clamping base and having
a top surface spaced from a top surface of the jaw body;
a bottom surface spaced from the top surface of the clamping groove; and
a side surface extending from an edge of the top surface of the clamping groove away from the center of the clamping base to an edge of the bottom surface of the clamping groove away from the center of the clamping base;
an abutting protrusion formed between the top surface of the jaw body and the top surface of the clamping groove and extending from the side surface of the clamping groove toward the center of the clamping base; and
wherein a distance defined from the bottom surface of the clamping groove of each of the at least one jaw of each one of the clamping members of the clamping unit to a bottom surface of the bottom base ranges from 850 millimeters to 1000 millimeters.

2. The rim drilling and milling machine as claimed in claim 1, wherein the bottom surface of the clamping groove of each of the at least one jaw of each one of the clamping members of the clamping unit is a horizontal plane surface.

3. The rim drilling and milling machine as claimed in claim 2, wherein the clamping groove of each of the at least one jaw of each one of the clamping members of the clamping unit has a chamfer extending obliquely and downwardly from an edge of the bottom surface of the clamping groove near the center of the clamping base.

4. The rim drilling and milling machine as claimed in claim 1, wherein each one of the clamping members has multiple said jaws arranged longitudinally at spaced intervals.

5. The rim drilling and milling machine as claimed in claim 2, wherein each one of the clamping members has multiple said jaws arranged longitudinally at spaced intervals.

6. The rim drilling and milling machine as claimed in claim 3, wherein each one of the clamping members has multiple said jaws arranged longitudinally at spaced intervals.

7. The rim drilling and milling machine as claimed in claim 4, wherein the top surface of the jaw body of one of two adjacent said jaws of each one of the clamping members near the center of the clamping base is lower than the bottom surface of the clamping groove of the other one of the two adjacent jaws of each one of the clamping members away from the center of the clamping base.

8. The rim drilling and milling machine as claimed in claim 5, wherein the top surface of the jaw body of one of two adjacent said jaws of each one of the clamping members near the center of the clamping base is lower than the bottom surface of the clamping groove of the other one of the two adjacent jaws of each of the clamping members away from the center of the clamping base.

9. The rim drilling and milling machine as claimed in claim 6, wherein the top surface of the jaw body of one of two adjacent said jaws of each one of the clamping members near the center of the clamping base is lower than the bottom surface of the clamping groove of the other one of the two adjacent jaws of each of the clamping members away from the center of the clamping base.

10. The rim drilling and milling machine as claimed in claim 7, wherein the clamping unit has three said clamping members arranged around the center of the clamping base at equiangular intervals.

11. The rim drilling and milling machine as claimed in claim 8, wherein the clamping unit has three said clamping members arranged around the center of the clamping base at equiangular intervals.

12. The rim drilling and milling machine as claimed in claim 9, wherein the clamping unit has three said clamping members arranged around the center of the clamping base at equiangular intervals.
